(19) United States
(12) Patent Application Publication
(10) Pub. No.: US 2004/0201700 A1
(43) Pub. Date: Oct. 14, 2004

(54) Separate-type camera lens vehicle reversal monitoring device

(76) Inventor: Chao-Ting Ho, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/947,400

(22) Filed: Sep. 7, 2001

(51) Int. Cl. H04N 5/225

(52) U.S. Cl. 348/207.99; 348/296; 348/312

(57) ABSTRACT

A separate-type camera lens vehicle reversal monitoring device comprised of an individually disposed camera lens, imaging component, image processor, and power supply circuit that are interconnected by a transmission cable, an arrangement that enables minimum component exposure and simple installation which increases product utility and provides for vehicle reversal safety.

### BACKGROUND OF THE INVENTION

1) Field of the Invention

The invention herein relates to a separate-type camera lens vehicle reversal monitoring device comprised of an individually disposed camera lens, imaging component, image processor, and power supply circuit that are interconnected by a transmission cable, an arrangement that enables minimum component exposure and simple installation which increases product utility and provides for vehicle reversal safety.

2) Description of the Prior Art

As is commonly known, the rear-view mirrors at the left and right sides of a vehicle are utilized to assist the driver while a vehicle is reversing; however, the field of vision of rear-view mirrors is limited and due to the numerous blind angles present, vehicle reversal based on such a limited field of vision can be quite dangerous; to improve the conventional rear-view mirror-based vehicle reversal model, vehicle reversal monitoring devices were introduced on the market; present generation conventional vehicle reversal monitoring devices are typically comprised of a camera lens, an imaging component, an image processor, and a power supply and, furthermore, since the camera lens and controller circuit board of the said conventional devices are integrated into a single component, the physical assemblage is excessively large and the design additionally requires the fitting of an outer housing structure that further adds to difficulties which, given the limited space of vehicle interiors, also makes it problematic to find a suitable installation site; furthermore, the excessively large physical dimensions of the conventional devices are such that when installed on vehicles, they are quite obvious and easily susceptible to damage and even removal; additionally, the placement of the camera lens and controller circuit board integrated into a single component within an outer housing increases heat dissipation and moisture difficulties. To overcome the existent shortcomings of the conventional product, while increasing utilization convenience and practicality, the inventor of the invention herein addressed the said shortcomings based on many years of experience gained while engaged in the related specialized fields by conducting research and development as well as repeated testing and refinement to ensure that the invention herein is capable of optimal utility, which culminated in the completion of the separate-type camera lens vehicle reversal monitoring device of the present invention.

### SUMMARY OF THE INVENTION

Therefore, the primary objective of the invention herein is to provide a separate-type camera lens vehicle reversal monitoring device comprised of a lens imaging component and an image processing/power supply circuit board that are individually disposed and connected by a transmission cable that enables communication between them, an arrangement that enables minimum component exposure and, furthermore, simple installation, increased vehicle reversal safety, and enhance product utility.

To enable the examination committee to further understand the innovative features and technological content as well as the advantages of the invention herein, the brief description of the drawings below is followed by the detailed description of an embodiment of the invention herein.

### BRIEF DESCRIPTION OF THE DRAWINGS

FIG. 1 is a structural diagram of the invention herein.

FIG. 2 is a block diagram of the lens imaging component 1 of the invention herein.

FIG. 3 is a block diagram of the image processing/power supply board 3 of the invention herein.

### DETAILED DESCRIPTION OF THE INVENTION

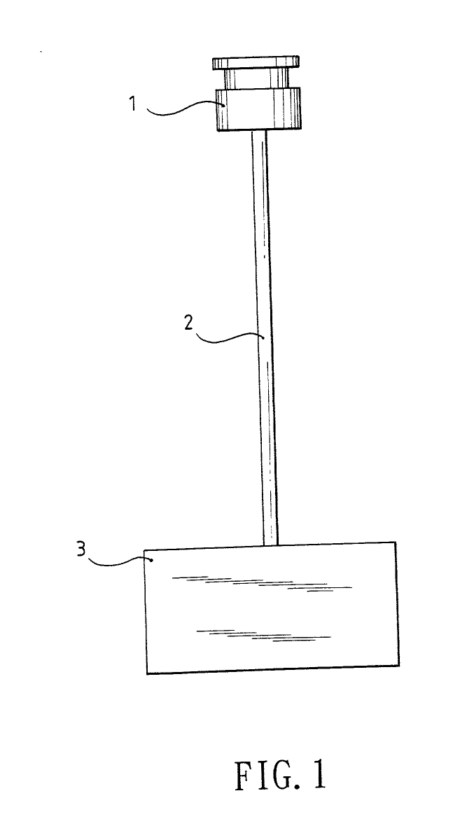

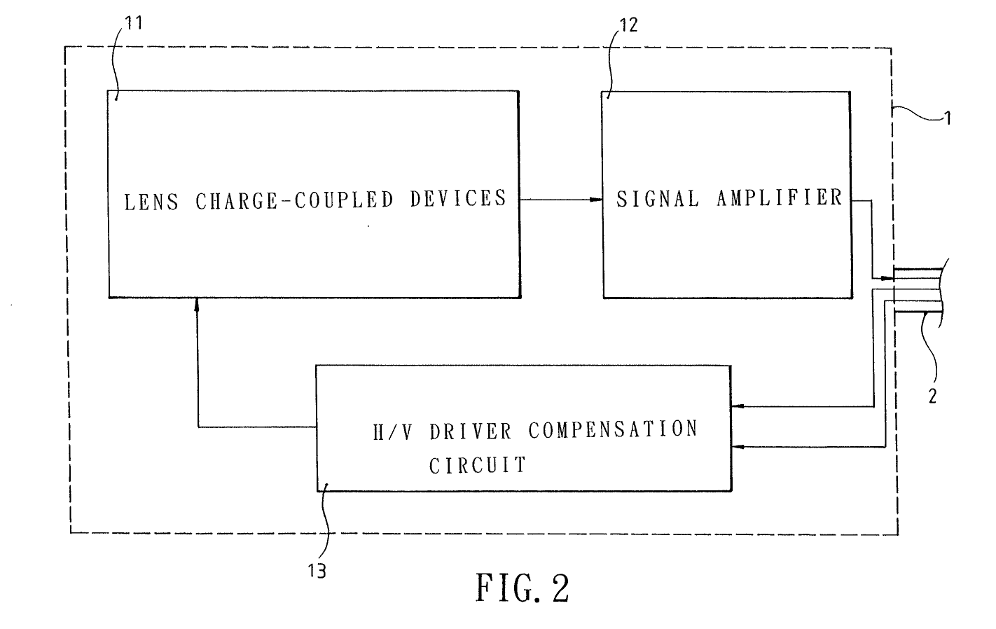

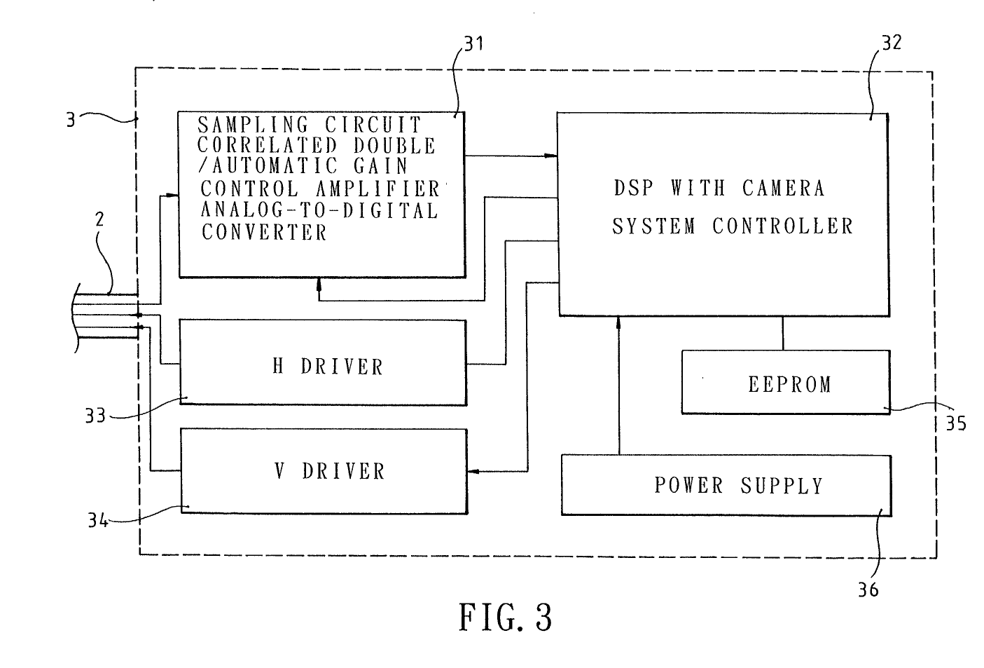

The invention herein provides a separate-type camera lens vehicle reversal monitoring device; referring to FIG. 1, FIG. 2, and FIG. 3, the present invention is comprised of a lens imaging component 1 and an image processing/power supply circuit board 3 that are individually disposed and connected via a transmission cable 2 that enables communication between them, wherein the said lens imaging component 1 consists of a lens charge-coupled device 11, a signal amplifier 12, and a horizontal/vertical (H/V) driver compensation circuit 13; the said image processing/power supply circuit board 3 consists of a correlated double sampling circuit/automatic gain control amplifier 31, a digital signal processor (DSP) with camera system controller 32, a horizontal (H) driver 33, a vertical (V) driver 34, an electrically erasable programmable read only memory (EEPROM) 35, and a power supply 36, with the transmission cable 2 of up to approximately 100 centimeters in length interconnected between the said circuits and components to enable signal transfers and thereby complete the installation of the separate-type lens vehicle reversal monitoring device of the present invention.

The basic operating principle of the invention herein involves the outputting of an object image signal from the lens charge-coupled device 11 to the correlated double sampling circuit/automatic gain control amplifier 31 for processing, following which a de-multiplexer performs a signal analysis and then forwards the signal into a matrix operation for resolution into the three primary colors (red, green, and blue). The remaining signal operation is handled by an ordinary standard display unit, the operating principles and applications thereof are well-known to individuals familiar with the associated technology and, therefore, requires no further elaboration.

While the preceding detailed description conveys in general a workable embodiment of the present invention, the said embodiment shall not be construed as a limitation of the scope and claims of the invention herein and, furthermore, all adaptations and modifications based on the technology and spirit of the invention herein shall remain protected within the patented scope of the invention herein.

In summation of the foregoing section, since the invention herein is not only of an original spatial arrangement, but also capable of greater functional utility and possesses utmost practical value and, furthermore, the disclosure of an identical or similar product has not been observed in the prevailing market, the present invention is submitted to the examination committee for review and the granting of the commensurate patent rights.

1. A separate-type camera lens vehicle reversal monitoring device comprised of a lens imaging component and an image processing/power supply circuit board that are individually disposed and connected via a transmission cable that enables communication between them, wherein the said lens imaging component consists of a lens charge-coupled device, a signal amplifier, and a horizontal/vertical (H/V) driver compensation circuit; the said image processing/power supply circuit board consists of a correlated double sampling circuit/automatic gain control amplifier, a digital signal processor (DSP) with camera system controller, a horizontal (H) driver, a vertical (V) driver, an electrically erasable programmable read only memory (EEPROM), and a power supply, with the said transmission cable of up to approximately 100 centimeters in length interconnected between the said circuits and components to enable signal transfers and thereby complete the installation of the separate-type lens vehicle reversal monitoring device of the present invention.
